(19) United States
(12) Patent Application Publication
(10) Pub. No.: US 2024/0156110 A1
(43) Pub. Date: May 16, 2024

(54) GLUTEN-FREE PIZZA CRUST WITH A LIGHT, AERATED AND CRISPY STRUCTURE

(71) Applicant: SOCIÉTÉ DES PRODUITS NESTLÉ S.A., Vevey (CH)

(72) Inventors: ANJNA DEVI, Solon, OH (US); JIAN LI, Chagrin Falls, OH (US); MOLLY KEARN, Macedonia, OH (US); RICCARDO LANDI, Hudson, OH (US)

(21) Appl. No.: 18/550,744

(22) PCT Filed: Mar. 18, 2022
(86) PCT No.: PCT/EP2022/057099

§ 371 Date: Sep. 15, 2023

Related U.S. Application Data
(60) Provisional application No. 63/163,179, filed on Mar. 19, 2021.

(51) Int. Cl. A21D 13/066; A21D 2/18; A21D 6/00; A21D 13/41

(52) U.S. Cl. CPC A21D 13/066; A21D 2/186; A21D 6/003; A21D 13/41

(57) ABSTRACT

The present invention relates generally to the field of food and nutrition. In particular, the present invention relates to gluten-free food product. Pizza is a very popular food globally. Gluten-free pizza has recently become available. The present invention provides a gluten-free pizza crust with a light, aerated and, yet, crispy structure. One embodiment of the present invention relates to a gluten-free pizza crust made from a gluten-free pizza dough comprising gluten free wheat starch, salt, yeast and water, wherein the pizza dough was proofed for at least 15 minutes.

The present invention relates generally to the field of food and nutrition. In particular the present invention relates to gluten-free food product. Pizza is a very popular food globally. Gluten-free pizza has recently become available. The present invention provides a gluten-free pizza crust with a light, aerated and, yet, crispy structure. One embodiment of the present invention relates to a gluten-free pizza crust made from a gluten-free pizza dough comprising gluten free wheat starch, salt, yeast and water, wherein the pizza dough was proofed for at least 15 minutes.

Pizza is one of the world's most popular foods today. Modern pizza has its origins likely in Naples, Italy, in the 18th or early 19th century. At that time pizza was usually sold out of pizza bakeries which were often open-air stands. Italian immigrants brought pizza to the United States probably in the late nineteenth century.

Since then, pizza has become very popular worldwide. Several styles of pizza have evolved in different regions of the world, that may differ from the original Italian style pizza. In the United States, for example, very popular are Chicago-style pizza, New York-style pizza, Neapolitan-style pizza, California-style pizza, Greek-style pizza. Detroit-style pizza, Sicilian-style pizza and St. Louis-style pizza.

Originally pizza contained as toppings at least a tomato-based sauce, cheese, and optionally further toppings.

Nowadays, also the crust used in pizza varies, for example, to meet different consumer preferences. Typically, pizzas are classified as thin-crust pizza or thick-crust pizza.

On element that is in particular loved by pizza consuming consumers is the light, aerated and crispy texture a good pizza crust typically has. All these properties are typically the result of the presence of gluten. Gluten is a protein present, for example in wheat flour. When mixing wheat flour with water, the hydration will cause gluten to swell and to form a continuous network of fine gluten strands. These gluten strands cause the pizza dough to be elastic and extendable. As a result, gas bubbles that are generated, e.g., by evaporating water during baking or by yeast activity are trapped in this network, resulting in the light aerated structure. A high heat in the oven will result in a crispy surface of the pizza crust.

However, while the presence of gluten has many advantages from a texture perspective in a pizza crust, unfortunately, note every consumer, for example consumers suffering from celiac disease, can tolerate gluten. Celiac disease is a disease that can occur in genetically predisposed people. About 1% of all people worldwide are estimated to suffer from some form of celiac disease. In people suffering from celiac disease, the ingestion of gluten may lead to gastrointestinal discomfort and may even lead to damage in the small intestine.

For such consumers that should not or do not want to consume gluten with their diet, gluten-free pizza is available on the market today.

For example, WO2015169778A1 relates to a gluten-free or gluten-reduced bread dough comprising corn starch, potato starch and tapioca starch. Further aspects are the method for the preparation of a gluten-free or gluten-reduced bread dough product as well as baked dough products prepared by said method.

WO2015173148A1 relates to gluten-free food products and in particular, to gluten-free bread comprising starch-containing material and Brassicaceae seed protein. Despite all these exciting propositions there is still a need in the art to provide a gluten-free pizza crust that delivers the same aeration, lightness and crispiness that a pizza crust containing gluten. The present inventors have addressed this need.

Any reference to prior art documents in this specification is not to be considered an admission that such prior art is widely known or forms part of the common general knowledge in the field.

The object of the present invention is it to enrich or to improve the state of the art and in particular to provide a gluten-free wheat-based pizza crust with a similar, same, or even better aeration, lightness and crispiness that a pizza crust containing gluten, or to at least provide a useful alternative to solutions existing in the art.

The inventors were surprised to see that the object of the present invention could be achieved by the subject matter of the independent claims. The dependent claims further develop the idea of the present invention.

Accordingly, the present invention provides a gluten-free pizza crust made from a gluten-free pizza dough comprising gluten-free wheat starch, salt, yeast and water, wherein the pizza dough was proofed for at least 15 minutes.

The present invention further provides a process for making a gluten-free pizza crust in accordance with the present invention. The subject matter of the present invention also extends to a prepared pizza obtained by or obtainable with the process of the present invention.

As used in this specification, the words “comprises”, “comprising”, and similar words, are not to be interpreted in an exclusive or exhaustive sense. In other words, they are intended to mean “including, but not limited to”.

The present inventors have shown that by preparing a gluten-free pizza crust from a gluten-free pizza dough based on gluten-free wheat starch and by letting the gluten-free pizza dough proof for at least 15 minutes, it is possible to achieve the objective of the present invention. The combination of the use of gluten-free wheat starch and a proofing step is remarkable, as normally, a proofing step would not be advised for gluten-free pizza doughs as the dough—due to the absence of gluten—would not be able to hold any significant amount of gas bubbles. Yet, contrary to this perception in the art, the inventors found that a pizza crust prepared from a dough with a composition in accordance with the present invention and by using the method of the present invention was at least as good in aeration, lightness and crispiness as a comparable pizza crust containing gluten, and was usually even better.

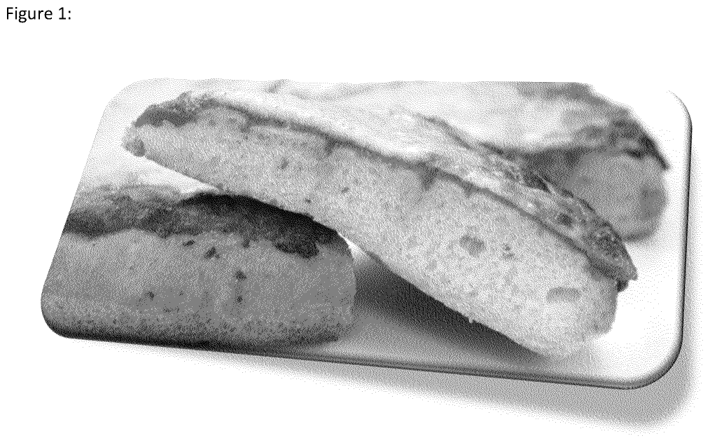

FIG. 1 shows a crust cross section of the pizza crust of the present invention.

Consequently, the present invention relates in part to a gluten-free pizza crust made from a gluten-free pizza dough comprising gluten free wheat starch, salt, yeast and water, wherein the pizza dough was proofed for at least 15 minutes.

The pizza crust may be only the baked pizza dough, or may be a pizza dough with one or more toppings, usually referred to as pizza or pizza bread. Any toppings that are typically used for pizza may be used. For example, the toppings may be selected from the group consisting of tomato-based sauce, cheese, pepperoni, salami, mushrooms, onions, sausage, egg, anchovies, artichokes, bacon, olives, peppers, pineapple, spinach, or combinations thereof.

The term “gluten-free” shall mean that the level of gluten in a product is harmless. Typically, a consumption of less than 10 mg (10 ppm) of gluten per day is considered harmless. The regulation of the label “gluten-free” varies by country. For the purpose of the present invention, the term “gluten-free” may mean in accordance with Codex Alimentarius that the product contains gluten in an amount of 20 ppm (=20 mg/kg) or less. In one embodiment of the present invention, the term “gluten-free” may mean that the product does not contain gluten.

A pizza for the purpose of the present invention may comprise an essentially flat crust with a rim topped with at least a tomato-based sauce and a cheese. For example, for the purpose of the present invention, the pizza may also be a Calzone-type pizza.

The gluten-free pizza crust may be a prepared gluten-free pizza crust.

For the purpose of the present invention, a pizza crust and/or a pizza shall be considered as “prepared” if it can be made ready for consumption, simply by subjecting the prepared pizza crust and/or a pizza to a heat treatment. For example, a prepared pizza crust and/or a pizza may be characterized in that no further ingredients need to be added to the pizza before consumption.

After preparation, the prepared pizza crust and/or a pizza will be distributed to the consumer. For this, it is preferred if the prepared pizza crust and/or a pizza is chilled or frozen to guarantee product freshness and safety. Also, to ensure product safety and easy handling during distribution and sales, the prepared pizza may be packaged. Typically, such a prepared pizza in accordance with the present invention may be packaged by overwrapping the pizza crust and/or a pizza in a sealed barrier paper wrap, or a plastic wrap. Additionally, the wrapped pizza may be packaged in pa carton, for example a pizza carton.

In accordance with the present invention, the gluten-free pizza crust is made from a gluten-free pizza dough comprising gluten-free wheat starch, salt, yeast and water. It may be beneficial if the wheat starch is first combined with the water to allow an autolysis of the wheat-starch, then yeast is added and finally, salt is added as well. It may be beneficial not to combine salt and yeast directly, as the salt may have a negative impact of the yeast activity.

Once a dough comprising gluten-free wheat starch, salt, yeast and water is formed it may be allowed to proof. Then the proofed dough may be separated into individual portions which are then brought into the form of the pizza crust. Once in the form of a pizza crust, the dough may be proofed again, before optionally toppings are added and the pizza crust is baked.

The total proofing time required will depend, for example, on the temperature at which the dough is proofed and, on the amount and activity of the yeast that is used. Typically, however, the total proofing time is at least 15 mins, for example at least 20 minutes, for example at least 30 minutes, for example at least 60 minutes, for example at least 90 minutes, for example at least 120 minutes, for example at least 180 minutes or for at least 240 minutes.

For example, the gluten free pizza crust in accordance with the present invention may comprise ingredients selected from the group consisting of gluten free wheat starch, buckwheat flour, rice starch, sugar, salt, yeast, oil and water.

Also, the gluten free pizza dough in accordance with the present invention may comprise ingredients selected from the group consisting of gluten free wheat starch, buckwheat flour, rice starch, sugar, salt, yeast, oil and water.

In certain embodiments of the present invention with which the inventors have obtained very good results, the pizza dough comprises 40-50 weight-% gluten free wheat starch, 0.5-3 weight-% buckwheat flour, 0.5-3 weight-% rice starch, 0.5-3 weight-% sugar, 0.5-3 weight-% salt, 0.5-3 weight-% yeast, 0.5-3 weight-% oil and 35-50 weight-% water.

Consequently, the present invention relates in part to a gluten-free pizza crust, wherein the pizza dough comprises 40-50 weight-% gluten free wheat starch, 0.5-3 weight-% buckwheat flour, 0.5-3 weight-% rice starch, 0.5-3 weight-% sugar, 0.5-3 weight-% salt, 0.5-3 weight-% yeast, 0.5-3 weight-% oil and 35-50 weight-% water.

The gluten-free pizza crust and/or the pizza dough may further comprise ingredients selected from the group consisting of psyllium fiber, guar gum, flax seed, or combinations thereof.

Psyllium and guar gum are both soluble fibers that can be used as thickeners, but are also considered helpful in the management of hyperlipidemia, for example.

Flaxseed is often considered a healthy ‘superfood’ and good for the prevention of diabetes and heart disease as it contains omega-3 essential fatty acids, lignans, and soluble and insoluble fiber.

For example, in one embodiment of the present invention that performed particularly well in achieving the objective of the present invention, the gluten free pizza crust and/or the pizza dough in accordance with the present invention comprised 40-50 weight-% gluten free wheat starch, 0.5-3 weight-% buckwheat flour, 0.5-3 weight-% rice starch, 0.5-3 weight-% sugar, 0.5-3 weight-% salt, 0.5-3 weight-% yeast, 0.5-3 weight-% oil, 35-50 weight-% water, 0.1-1 weight-% psyllium fiber, 0.1-2 weight-% guar gum, 0.1-2 weight-% flax seed.

For example, in on embodiment of the present invention the gluten free pizza crust and/or the pizza dough in accordance with the present invention comprised 43-48 weight-% gluten free wheat starch, 0.1-3 weight-% buckwheat flour, 0.1-3 weight-% rice starch, 1-3 weight-% sugar, 2-3 weight-% salt, 2-3 weight-% yeast, 2-3 weight-% oil, 35-45 weight-% water, 0.2-0.8 weight-% psyllium fiber, 0.8-1.2 weight-% guar gum, 0.7-1.5 weight-% flax seed.

The gluten-free pizza crust and/or the pizza dough may further comprise ingredients selected from the group consisting chick pea flour, whey powder, non-fat dry milk, hydroxypropylmethylcellulose (HPMC) gum, or combinations thereof.

In one embodiment of the present invention, the gluten free pizza crust and/or the pizza dough in accordance with the present invention comprises gluten free wheat starch, buckwheat flour, rice starch, sugar, salt, yeast, oil, water, psyllium fiber, guar gum, flax seed, chick pea flour, whey powder, non-fat dry milk, and hydroxypropylmethylcellulose (HPMC) gum.

The present inventors have tested the taste and texture preference of their gluten-free pizza crust in accordance with the present invention and have obtained particularly good results, when the pizza crust has an average crust thickness in the range of 15-25 mm.

Baking time and temperature also has an impact on the crispiness and aeration of the resulting pizza crust. The inventors were able to produce a great aeration, lightness and—at the same time—crispiness in the pizza crust obtained from the pizza dough of the present invention after baking, when the dough was baked at a temperature above 200° C.

Very good results are obtained, when the pizza crust was baked at a temperature in the range of 240-325° C. for a time period in the range of 2-10 minutes.

The inventors found it further helpful to produce a gluten free pizza crust with a shape that the consumer expects from a normal pizza crust, if the gluten-free pizza crust was baked in a pan. Hence, the pizza crust of the present invention may be baked in a pan at a temperature in the range of 240-325° C. for a time period in the range of 2-10 minutes.

The scope of the present invention also extends to a process for making a gluten-free pizza crust in accordance with the present invention.

Such a process for making a gluten-free pizza crust in accordance with the present invention may comprise the steps of
preparing a dough by mixing the ingredients,
forming the dough into at least one dough ball,
pressing a dough ball into the shape of a pizza crust,
transferring the pressed dough into a pan
proofing the dough in the pan, and
baking the preformed pizza crust.

The process for making a gluten-free pizza crust in accordance with the present invention may further comprise the steps of applying the toppings on top of the pizza dough in the pan and/or on top of the baked pizza crust.

A person skilled in the art will know how to best apply the toppings to the pizza crust. It may be preferred to first add a tomato-based sauce, then to add a cheese and then to potentially add other toppings. Optionally, the other toppings may be covered with a further layer of cheese to ensure a cheesy crust on top of the pizza. It may also be prepared to first add a layer of cheese and then to add the tomato-based sauce, before all further toppings are added. The idea here is that the melting first layer of cheese will protect the pizza crust from the water in the tomato-based sauce, which might cause the crust to become soggy. However, the traditional way to make pizza is to first add the tomato sauce, then to add the cheese and then to add all further toppings including an optional final layer of cheese. Hence, in one embodiment of the present invention applying the toppings comprises a first step of applying a sauce to the top of the baked crust and a second step where further toppings are applied on top of the sauce.

Adding the toppings on top of the pizza dough before baking has the advantage that a fully baked pizza is sold. This will further add to product safety and will allow even that the pizza is consumed cold.

Accordingly, the subject matter of the present invention comprises a process for making a gluten-free pizza crust in accordance with the present invention, further comprising the step of applying pizza toppings on top of the dough in the pan before the pizza crust is baked. For example, the pizza toppings may be applied on top of the proofed dough in the pan.

Adding the toppings on top of the baked pizza crust has the advantage that the consumer will experience fully the transformation of a pizza crust topped with ingredients into a delicious pizza that can be consumed once the pizza was baked in the consumer's home.

As stated above, the gluten free pizza dough comprises at least gluten free flour and/or gluten free starch, yeast, water and salt. For the purpose of the present invention, it is preferred if the dough comprises gluten free flour and/or gluten free starch, water, salt, yeast, oil and sugar. The ingredients are mixed and kneaded into a dough.

In one embodiment of the process of the present invention the dough comprises 43-48 weight-% gluten free wheat starch, 0.1-3 weight-% buckwheat flour, 0.1-3 weight-% rice starch, 1-3 weight-% sugar, 2-3 weight-% salt, 2-3 weight-% yeast, 2-3 weight-% oil, 35-45 weight-% water, 0.2-0.8 weight-% psyllium fiber, 0.8-1.2 weight-% guar gum, and 0.7-1.5 weight-% flax seed.

In general, if the dough of the present invention comprises flax seed, it is preferred if the flax seed are soaked in water before they are mixed with the other ingredients. For example, they may be soaked for at least 30 mis, at least one hour, at least 2 hours, or at least 6 hours in water at about room temperature. Heating the water will reduce the soaking time. As whole flax seeds have a shiny, hard outer coating, this can be unpleasant to enjoy and that can make it difficult for the body to break down after ingestion. As a consequence, the nutrients in flax seeds can be less available when the seeds are used unsoaked. Hence, in one embodiment of the present invention wherein the dough comprises flax seeds, the flax seeds are soaked in water before they are mixed with the other ingredients.

When the ingredients are mixed, this can be done in a container, for example a mixing bowl. Experience has shown that the mixing is more efficient and that the resulting dough can be more easily removed from the container if the contained is coated with an oil. Hence, in one embodiment of the process of the present invention the ingredients are mixed in a mixing bowl that is coated with oil.

The dough is then formed into at least one dough ball.

A “dough ball” of the present invention is a portioned part of the dough. It may be a block, lump or chunk of the dough. Preferably it is in a cube-like or a rounded ball or flattened ball-like form, as for example typically formed as approximately a handful of dough.

Preferably, the dough ball used in the process of the present invention is portioned for a regular size or family size pizza product. Preferably, the dough ball is portioned to a wet-weight before use from 100 g to about 600 g, preferably from 150 g to 450 g, more preferably from 200 g to 300 g, per dough ball.

The process comprises the step of proofing the dough, for example the pressed dough, in the pan.

The process may comprise a further step of proofing the dough portion before flattening it in the form of a pizza crust in the pressing step.

The process may also comprise a further step of proofing the dough directly after preparing it by mixing the ingredients.

Proofing of the dough may be achieved by letting it sit for a prolonged time at a temperature between about 20° C. and 37° C., before pressing.

For example, it may be preferred if the proofing is carried out at a temperature in the range of about 18° C. to 40° C., for a time in the range of about 30 minutes to 24 hours.

The inventors were surprised to see that—despite using gluten-free wheat starch proofing steps led to an improved aeration and lightness of the resulting pizza crust.

In a typical wheat flour dough, the gluten matrix, composed mainly of the protein network of gluten, starch granules, and water encloses the fermentation gas in little bubbles. The bubbles are held in place by the dough matrix. As a consequence, as fermentation proceeds, the size of the bubbles and their number increases and the dough rises. On the other hand, in gluten-free wheat starch results in a dough in which the proteins do not possess the network-forming properties typically found in gluten. A somewhat runny dough will result, and proofing will only lead to some foaming, however, without allowing the bough to rise as in a gluten-containing dough.

Hence, was surprising that with the dough formulation of the present invention proofing let to an improved texture of the resulting crust.

Ideally, the dough is proofed after pressing the dough ball into the pan.

The proofing of the dough in the pan was found to be in particularly decisive for the quality of the obtained pizza crust. The inventors have obtained very good results, when the dough in the pan is proofed for a time period in the range of about 30-60 minutes, at a relative humidity in the range of about 60-80%, and at a temperature in the range of about 18-40° C.

It may further be preferred if the process comprises a further step of applying an oil onto the surface of the dough ball before subjecting it to the pressing step. Preferably, the oil is applied to the surface of the dough ball by spraying. The oil can be applied to the top surface, to the bottom surface or two both surfaces of the dough ball. It has been surprisingly found by the inventors, that applying an oil onto the surface of the dough ball allows a more efficient pressing step. For example, the sticking of the dough to the surfaces of the pressing device is reduced and the time needed for the pressing step in the process of the present invention can be further reduced as well. Also, the surface of the preformed pizza crust tends to be smoother. Preferably, the oil is a vegetable oil.

The pressing may be carried out by any means known in the art. The inventors have obtained very good results using a heated press. A very useful process for the pressing step is described, for example, in WO2021009151A1, herein fully incorporated by reference.

For example, the inventors have obtained very good results, when the pressing was carried out with a heated press operating at a temperature in the range of about 60° C. to 220° C.

For example, in the process for making a gluten-free pizza crust in accordance with the present invention, the dough ball may be pressed into the shape of a preformed pizza crust in a heated press operating at a temperature in the range of about 60° C. to 150° C. with a pressure in the range of about 25-30 bar for a time in the range of 2-5 s.

In one embodiment of the present invention the dough ball is pressed in a pan into the shape of a preformed pizza crust.

The heated press may comprise a flat surface onto which the dough ball is placed and a heating plate, which is pressed onto the dough ball on the flat surface to generate the preformed pizza crust.

In one embodiment of the present invention, the heating plate is heated. Preferably, the heating place is heated to a temperature from 60° C. to 125° C., preferably from 80° C. to 120° C., more preferably from 90° C. to 115° C. Active heating of the heating plate for the present method was found to accelerate the industrial process of manufacturing preformed pizza crusts. The process can be run much faster and the dough disks readily detach much better from the heating plate without sticking to that plate, than when the heating plate is not actively heated.

In another embodiment of the present invention, the flat surface, onto which the dough ball is placed in the method of the present invention, is heated. This advantageously allows to already start to pre-bake the dough crust during its processing and thereafter also to better detach it again from the flat surface after the pressing process is terminated. Preferably, the flat surface is heated to a temperature of at least 120° C., preferably of at least 160° C., more preferably at least 180° C.

The preformed pizza crust will then be baked. The baking step does not have to fully bake the pizza crust. It is sufficient, if the baking step results in a prebaked pizza crust. For example, the baking of the preformed pizza crust may be carried out at least 180° C. for at least 5 minutes.

Typically, the pizza crust of the present invention is distributed and sold either in a chilled or a frozen form. Distributing and selling the pizza crust in a frozen from has the advantage that a safer storage for a longer shelf-life can be ensured.

Hence, in one embodiment of the present invention the process for making a gluten-free pizza crust in accordance with the present invention may further comprise the steps of freezing the prepared gluten-free pizza crust and packaging the frozen prepared gluten-free pizza crust.

Those skilled in the art will understand that they can freely combine all features of the present invention disclosed herein. In particular, features described for the product of the present invention may be combined with the process of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

The inventors have prepared and compared a typical comparable gluten-free pizza crust on the market today, a regular wheat flour based pizza crust and a gluten-free pizza crust in accordance with the present invention.

### Examples

| | Invention | Wheat | Comparable Gluten |
|---|---|---|---|
| | Formula | Flour | Free Blend available |
| | (FIG. 1) | Crust | on the market |
| Wheat starch, buckwheat | 51.3% | — | |
| flour, rice starch, psyllium | | | |
| fiber, guar gum, flax blend | | | |
| Wheat flour | 0% | 55% | 0% |
| Buckwheat flour, rice flour, | — | — | 51.4% |
| rice starch blend, psyllium | | | |
| fiber, guar gum, flax blend | | | |
| Sugar | 2% | 2% | 2% |
| Salt | 1.5% | 2% | 1.6% |
| Yeast | 2.2% | 1% | 2.2% |
| Oil | 2% | 3% | 1.8% |
| Water | 41% | 37% | 41% |

### Method

Make a dough. Mix the dry flour ingredients with the sugar. Add water and oil and mix for 1-2 minutes at speed 1-2 of Hobart mixer. Add yeast and mix at speed 1-2 for 2 minutes. Scrape sides of mixing bowl. Add salt and mix for at speed 1-2 for 2 minutes. Scrape sides of bowl. Continue mixing at speed 2 until dough forms, stopping mixing every 2 minutes to scrape dough off sides of bowl.

The formed dough can then be divided into dough balls of 250 gm. The dough ball is pressed onto parchment paper with a dough press to create a flattened dough. The pressed dough is transferred to a pan. The pressed dough is proofed for 25 minutes at 30-45° C., 60-80% RH. The proofed dough is baked at 280-290° C. in an oven for 2-3 minutes to obtain a pizza crust.

For a wheat flour crust, the formed dough is divided into 250 gm dough balls and proofed for 50 min at 30-45° C., 60-80% RH, then pressed into a pizza crust shape. The shaped dough may then be baked at 280-290° C. in an oven for 2-3 minutes to obtain a pizza crust.

The obtained pizza crusts were tested and compared by a consumer panel as shown below. The characteristics of the pizza crusts were evaluated on scale from 0-5 with 5 being the best rating and 0 being the worst rating.

Results of the Test Analysis:

| | | Invention Formula | Wheat Flour | Comparable Gluten Free Blend |
|---|---|---|---|---|
| | | Example 1(FIG. 1) | Crust | available on the market |
| Appearance | Open cell/aerated (aerated -5) | 4.5 | 3 | 0.5 |
| Texture | Light/aerated (light -5) | 5 | 3 | 0 |
| | Crispy (crispy - 5) | 4.5 | 3.5 | 0 |
| | Chewy (chewy - 5) | 2 | 4 | 3 |
| | Gummy (gummy - 5) | 2 | 1 | 4 |
| Taste/flavor | Clean/light (clean - 5) | 5 | 2 | 1 |
| Measurement | Crust thickness (avg, mm) | 20.68 | 24.76 | 8.97 |

1. Gluten-free pizza crust made from a gluten-free pizza dough comprising gluten free wheat starch, salt, yeast and water, wherein the pizza dough was proofed for at least 15 minutes.

2. Gluten-free pizza crust according to claim 1, wherein the pizza dough comprises 40-50 weight-% gluten free wheat starch, 0.5-3 weight-% buckwheat flour, 0.5-3 weight-% rice starch, 0.5-3 weight-% sugar, 0.5-3 weight-% salt, 0.5-3 weight-% yeast, 0.5-3 weight-% oil and 35-50 weight-% water.

3. Gluten-free pizza crust in accordance with claim 1, comprising an ingredient selected from the group consisting of psyllium fiber, guar gum, flax seed, and combinations thereof.

4. Gluten-free pizza crust in accordance with claim 1, comprising an ingredient selected from the group consisting of chick pea flour, whey powder, non-fat dry milk, hydroxypropylmethylcellulose (HPMC) gum, and combinations thereof.

5. Gluten-free pizza crust in accordance with claim 1, wherein the pizza crust has an average crust thickness in the range of 15-25 mm.

6. Gluten-free pizza crust in accordance with claim 1, wherein the pizza crust was baked in a pan at a temperature in the range of 240-325° C. for a time period in the range of 2-10 minutes.

7. Process for making a gluten-free pizza crust comprising the steps of
preparing a dough by mixing gluten free wheat starch, salt, yeast and water,
forming the dough into at least one dough ball,
pressing a dough ball into the shape of a preformed pizza crust,
transferring the pressed dough into a pan
proofing the dough in the pan, and
baking the preformed pizza crust for at least 15 minutes.

8. Process for making a gluten-free pizza crust in accordance with claim 7, wherein the dough ball is pressed in a pan into the shape of a preformed pizza crust.

9. Process for making a gluten-free pizza crust in accordance with claim 7, comprising the step of applying pizza toppings on top of the dough in the pan before the pizza crust is baked.

10. Process for making a gluten-free pizza crust in accordance with claim 8, wherein the pizza toppings are applied on top of the proofed dough in the pan.

11. Process for making a gluten-free pizza crust in accordance with claim 7, wherein the dough comprises flax seed and wherein the flax seed are soaked in water before they are mixed with the other ingredients.

12. Process for making a gluten-free pizza crust in accordance with claim 7, wherein the dough ball is pressed into the shape of a preformed pizza crust in a heated press operating at a temperature in the range of about 60° C. to 150° C. with a pressure in the range of about 25-30 bar for a time in the range of 2-5 s.

13. Process for making a gluten-free pizza crust in accordance with claim 7, wherein the ingredients are mixed in a mixing bowl that is coated with oil.

14. Process for making a gluten-free pizza crust in accordance with claim 7, wherein the dough in the pan is proofed for a time period in the range of about 15-60 minutes, at a relative humidity in the range of about 60-80%, and at a temperature in the range of about 18-40° C.

15. Process for making a gluten-free pizza crust in accordance with claim 9, comprising the steps of freezing the prepared gluten-free pizza crust and packaging the frozen prepared gluten-free pizza crust.
